(19) United States
(12) Patent Application Publication
(10) Pub. No.: US 2006/0031642 A1
(43) Pub. Date: Feb. 9, 2006

(54) Circuit arrangement and method of a multiprocessor system

(76) Inventors: Martin Maenz, Eching (DE); Pavel Peleska, Grafelfing (DE); Martin Rau, Pullach (DE); Karl Sapotta, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/193,978

(22) Filed: Jul. 29, 2005

(30) Foreign Application Priority Data
Jul. 30, 2004 (DE) 10 2004 037 017.6

(51) Int. Cl. G06F 12/00

(52) U.S. Cl. 711/148

(57) ABSTRACT

With this circuit arrangement and the method associated therewith, time-critical procedures to be processed are adopted on assemblies with direct memory access and non time-critical procedures by processors which are arranged on neighboring assemblies.

### CROSS REFERENCE TO RELATED APPLICATIONS

This application claims priority to the German application No. 10 2004 037 017.6, filed Jul. 30, 2004 and which is incorporated by reference herein in its entirety.

### FIELD OF INVENTION

The invention relates to a circuit arrangement and method of a multiprocessor system.

### SUMMARY OF THE INVENTION

A multiprocessor system is used for instance, if the computing power of an individual processor is no longer sufficient to efficiently execute tasks to be processed. Several processors work in parallel in a multiprocessor system, in which they all respond to the same main memory. Multiprocessor systems with a closely coupled memory are also referred to as a Shared Memory Processor System. With this multiprocessor system, each processor has access to a common memory area which is referred to as a logical memory address space or a main memory.

With a Shared Memory Processor System SMP, the access time to the main memory is a very significant criterion for the efficiency of the system. A fast access time can be realized for example if processors and memories are then physically housed on the same assembly, since a wider memory interface between the processor and memory can now be provided for example. If, on the other hand, the memory access takes place on a separate memory assembly, the memory access times are longer as a result of the physical delays and as a result of the conversion to narrower interfaces.

The arrangement illustrated in FIG. 1 is applied in the case of an arrangement in which the processors are distributed on further assemblies due to insufficient space on the respective assemblies. With this arrangement, memory elements are located on the further assemblies, access to which can be had by the processors of the entire circuit arrangement.

With a distribution of processor power and memory capacity illustrated schematically in FIG. 2, parts of the memory capacity are housed with one or a number of processors on an assembly. In the case of this architecture, an increasing probability must be accounted for in the case of an increasing number of assemblies in that memory areas of adjacent assemblies are accessed, thereby resulting in longer access memory times.

Multiprocessor systems of this type are also used in telecommunications technology. Symmetrical multiprocessors closely coupled with a Common Memory have been used in these systems for several generations. Closely coupled means equipped with a common memory for all processors, because there are some data fields and/or databases in the switching software, which all switching processors frequently access and which in consequence are also frequently updated. These are the subscriber data base and the core image of the switching network for instance. In mobile radio applications, further extensive databases such as the Home Location Register HLR and the Visitor Location Register VLR are added. In the case of coordination processors for instance, up to 16 switching processor assemblies and a double memory assembly according to the architecture illustrated in FIG. 1 can form the switching processor system. The processor assemblies access the memory via a memory bus by means of fast serial connections. This memory bus determines the data throughput of the switching processor system.

A series of processor/memory assemblies are used in another multiprocessor system. A processor and a part of the Common Memory are housed on each assembly. This corresponds to the architecture illustrated in FIG. 2. The assemblies are linked to one another by means of a parallel bus.

The object of the invention is to specify a further multiprocessor system.

The object is achieved by the claims.

The invention is advantageous in that tasks to be processed are processed using a central memory in a faster and more efficient manner, thanks to the processors used.

The invention is advantageous in that the assemblies can be manufactured in a simplified and series-oriented manner.

The arrangement is advantageous in that simple hardware can be used in systems with a separate main memory, since only one assembly type is to be developed. The processor assemblies could be configured for example as an assembly variant without a main memory.

The invention is advantageous in that the partitioning of the tasks for the processors allows an asymmetrical memory access time to be used especially for heterogenous systems, such as systems for instance, whose in/output has a high protocol load.

The arrangement according to the invention is further advantageous in that only tasks of the processors need to be partitioned, whilst in the case of a system with a distributed main memory, both the tasks of the processors and also the data in the main memory have to be partitioned.

The object of the invention is particularly suited to processor systems, in which the processor load and the memory requirement of the application are in an imbalance in respect of one another.

Further features of the invention are apparent from the more detailed description below of the figure of the exemplary embodiment with reference to a schematic diagram.

### BRIEF DESCRIPTION OF THE DRAWINGS

FIG. 1 shows a multiprocessor system,

FIG. 2 shows an embodiment of a multiprocessor system, and

FIG. 3 shows a further multiprocessor system.

### DETAILED DESCRIPTION OF THE INVENTION

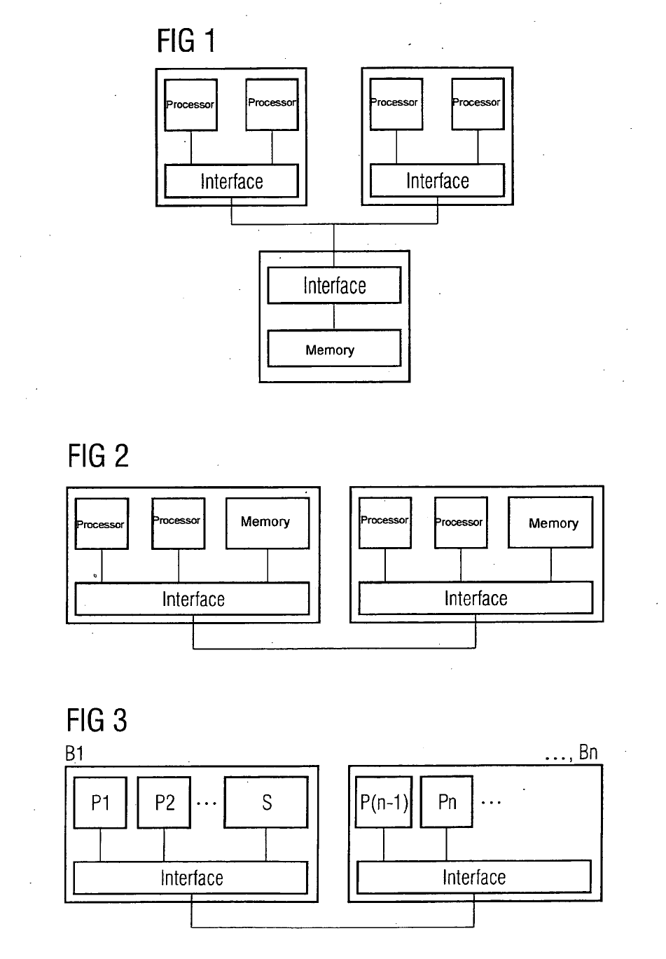

In both multiprocessor systems shown in FIGS. 1 and 2, the throughput is significantly restricted by the access times on the Common Memory. The essential reason for this is that the data from the Common Memory is not buffered in the processor caches, since a cache coherence protocol across many assemblies would be extremely expensive.

In accordance with the invention, the multiprocessor system is configured such that all switching processors and the Common Memory are housed on a single assembly. According to the architecture illustrated in FIG. 3, only the switching software which operates on the Common Memory in a throughput relevant manner is housed on a main assembly and further tasks are stored on a second processor assembly, in which an actual partitioning of the Common Memory to the assemblies does not occur.

FIG. 3 shows a schematic design of a multiprocessor system according to the invention. With this multiprocessor system, both one or a number of processors as well as a first main memory are housed on an assembly. According to the arrangement illustrated in FIG. 3, the entire common first main memory S is found on one assembly. With this embodiment according to the invention, the processors located on the assembly have a very fast access to the first main memory S arranged on the same assembly. The assemblies B1, . . . , Bn are connected to one another respectively via interfaces INT. The processors Pn-1, . . . , Pn on adjacent assemblies Bn are considered for the processing of further tasks, of service functions running in the background of a switching system for example. Access to the common first main memory S is structured such that tasks of the processors to be processed are partitioned into time-critical processes and less time-critical processes. In addition, accesses into tasks with high access rates and into those with lower access rates can be partitioned to the first main memory S. In the case of a telephone switching system, time-critical applications are predetermined by the actual switching technology, call processing and non time-critical applications, e.g. by the operation and maintenance of the system as well as extensive computer protocol processing for external interfaces.

With the arrangement illustrated in FIG. 3, it is also possible for further memories to be arranged on the processor assembly, in addition to the actual common main memory. This could be both a local memory which is assigned in each instance to the individual processor, or a cache memory, as is used in powerful processors.

The computing power of a Shared Memory Processor increases by means of the processor arrangement with an asymmetrical memory partition as illustrated in FIG. 3, by adding further processor assemblies, without having to accept the hitherto unavoidable deceleration of the memory access for a core of the system.

1-2. (canceled)

3. A circuit arrangement for a memory access of a multiprocessor system with at least a first and second assembly on which at least one processor is arranged in each instance and the processors are linked either directly or via interfaces in a cross-assembly manner, wherein
the first assembly comprises a first common main memory, in which the time-critical processes on the first assembly running on the processors have quick access to the first main memory, whilst non time-critical low priority procedures are adopted by processors which are arranged on the second assembly.

4. The circuit arrangement according to claim 3, wherein the arrangement is used for real-time applications.

5. A method for accessing a memory of a multiprocessor system comprising at least a first and a second component on which at least one processor is arranged in each instance and the processors are linked either directly or via interfaces in a cross-component manner, the method comprising:
providing a common main memory on the first component;
providing a quick access to the common main memory for time-critical processes on the first component; and
performing non time-critical low priority procedures by processors arranged on the second component.

6. A method according to claim 5, wherein the method is used for real-time applications.
